(19) United States
(12) Patent Application Publication
(10) Pub. No.: US 2018/0137844 A1
(43) Pub. Date: May 17, 2018

(54) The Configurable Music Station

(71) Applicant: SCHMICK, LLC, Houston, TX (US)

(72) Inventors: Luke Schmick, Houston, TX (US); Alexandra Schmick, Houston, TX (US)

(21) Appl. No.: 15/352,417

(22) Filed: Nov. 15, 2016

(51) Int. Cl. G10G 5/00; G10D 13/08; G10D 13/06; F16M 11/22; F16B 12/44; G09B 5/04; A63H 5/00; A63H 33/00

(52) U.S. Cl. CPC G10G 5/005; G10D 13/08; G10D 13/06; F16M 11/22; F16B 2012/446; G09B 5/04; A63H 5/00; A63H 33/00; F16B 12/44

(57) ABSTRACT

A musical learning apparatus comprising one or more interactive panels including side frame members, an upper frame member, and a lower frame member. The apparatus also includes one or more connectors disposed on at least one of the side frame members, upper frame member, and lower frame member. The musical learning apparatus also includes a plurality of upper brackets positioned on abutting upper interactive panel frame members, and a plurality of lower brackets positioned on abutting lower frame members. The apparatus also includes one or more wires that connect musical devices to at least one of the interactive panels using the connectors. Wherein, when the upper and lower brackets stabilize the abutting upper and lower frame members the musical devices are enabled.

### BACKGROUND OF THE DISCLOSURE

Musical toys such as music boxes are typically popular with young children. At least one reason for this is that toys that can stimulate the minds of children by allowing them to learn using both music and shapes, are more interesting to children than toys only having a shape or that only produces a sound These toys typically have no other educational benefit or aesthetic value.

Many of the toys discussed above are limited to producing a single sound or having only to press a button to hear a sound. This repetitive activation of a sound, without allowing children to use their creative ability, however rapidly loses its ability to maintain curiosity in children. Thus, in effect the toys become boring.

Moreover, toys that have different shapes today are overly simplified and children are not offered an opportunity to learn the simplest of structural components, and or the construction involved in creating the shapes or designs of the toys. Learning about the configuration of devices such as toys, are useful for school age children that are beyond the basic shapes and sounds, and are ready to more explore their creativity.

It is therefore desirable to have an apparatus that can be used to learn about music instruments. It is also desirable to have a safe toy that allows it to be configured into, simple two or three-dimensional model shapes and designs. It is also desirable to have a toy that allows users to learn basic structural components used to craft the model shapes and designs.

It is further desirable for the apparatus to be configurable into different shapes and designs by easily rearranging a few brackets, etc. Moreover, it is desirable to have an apparatus that can be configured to provide multiple users different amounts of space when interacting with the apparatus during collective educational development or entertainment.

Furthermore, it is desirable for the apparatus to serve as an educational tool while being aesthetically pleasing, and can produce music in an outdoor or indoor environment.

The subject matter of the present disclosure is directed to overcoming, or at least reducing the deficiencies of, one or more of the problems set forth above.

### SUMMARY OF THE DISCLOSURE

A musical learning apparatus comprising one or more interactive panels including side frame members, an upper frame member, and a lower frame member is provided. The apparatus also includes one or more connectors disposed on at least one of the side frame members, upper frame member, and lower frame member.

In one example, the learning apparatus includes a plurality of upper brackets positioned on abutting upper interactive panel frame members, and a plurality of lower brackets positioned on abutting lower frame members.

In yet another example, the learning apparatus also includes one or more wires that are used connect musical devices to at least one of the interactive panels using the connectors. When the upper and lower brackets stabilize the abutting upper and lower frame members the musical devices are enabled. In another example, the learning apparatus forms shapes or other designs when the interactive panels are stabilized. Moreover, the musical learning apparatus can form at least one of a rectangular prism, cube, Zig-Zag, square, or rectangle.

In another example, the learning apparatus has upper brackets and lower brackets that are angled in shape. The musical learning apparatus further involves using compression to stabilize the interactive panels. In yet another example, the musical learning apparatus has lower brackets that can be positioned on abutting lower frame members in a reversed position.

In yet another example, musical devices are disposed on the musical learning apparatus using a mounting screw assembly, wherein the mounting screw assembly includes a mounting screw, one or more washers, and a sheath.

In another example, the musical learning apparatus includes two or more panel stabilizers disposed at the base of the interactive panels, wherein at least one wire connects one or more musical devices to the interactive panels using the connectors.

In another example, the side frame members of the interactive panel are disposed within the panel stabilizers, wherein the musical devices are enabled when the panel stabilizers stabilize the interactive panel.

The foregoing summary is not intended to summarize each potential embodiment or every aspect of the present disclosure.

### BRIEF DESCRIPTION OF THE DRAWINGS

FIG. 1 illustrates a configurable music station (music station) in the form of a rectangular prism, according to the present disclosure.

FIGS. 2A-2C illustrate example views of an upper bracket joining the frames of music station interactive panels according to the present disclosure.

FIGS. 3A-3C illustrate example views of a lower bracket joining interactive panels (panels) of the music station according to the present disclosure.

FIG. 4. illustrates an angled or Zig-Zag configuration of the music station according to the present disclosure.

FIGS. 5A-5B illustrate panel stabilizers according to the present disclosure.

FIGS. 6A-6B illustrate example interactive panels of the music station being held upright using panel stabilizers, according to the present disclosure.

FIGS. 7A-7B illustrate a mounting screw used to mount musical devices to a panel according to the present disclosure.

FIG. 8 illustrates an example chime panel according to the present disclosure.

FIGS. 9A-9B illustrate examples of accessory members being attached to the music station, according to the present disclosure.

### DETAILED DESCRIPTION OF THE DISCLOSURE

Overview of the System

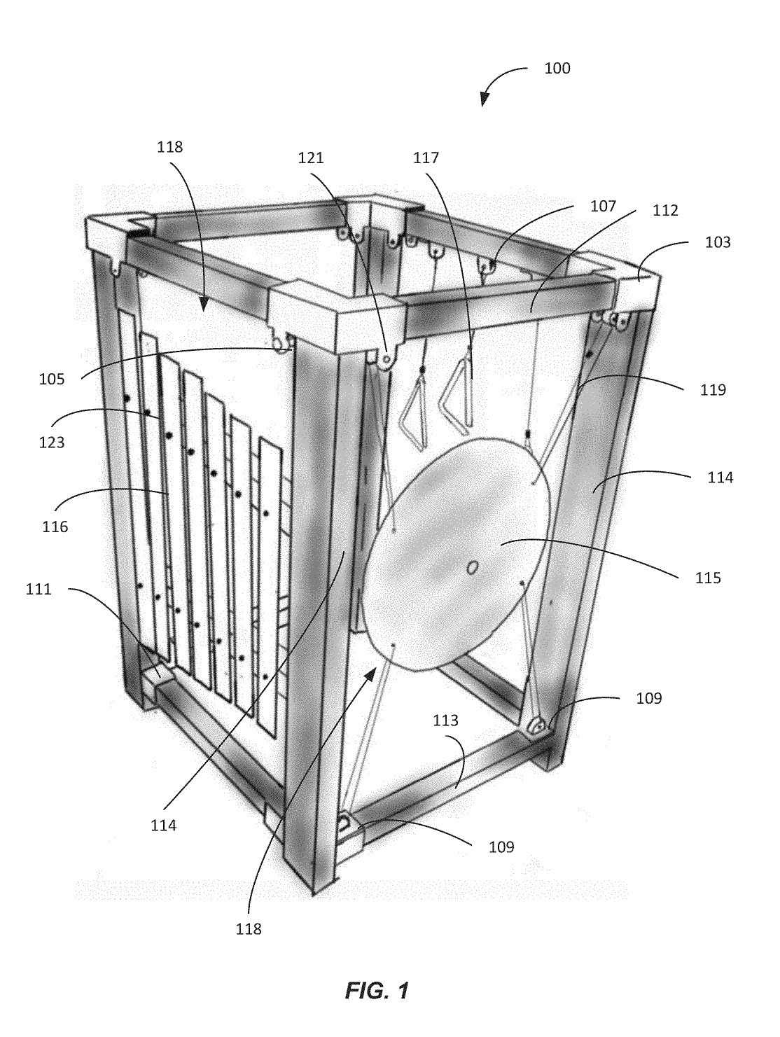

Referring to the illustration of FIG. 1, a configurable music station 100 is shown configured as a rectangular prism. The music station 100 is configurable in that the interactive panels 118, and or other parts of the music station 100 may be configured or arranged to form different shapes or designs e.g., rectangular prisms, cubes, Zig-Zag, square, rectangle, or the like.

The one or more interactive panels 118 (“panels”) may also have musical devices disposed thereon for producing sound. A music device can be a musical instrument that requires an accessory device (discussed below) for interacting with the musical device. For example, a musical device can be a cymbal, wherein the accessory device is a hammer or mallet for striking the cymbal to produce sound.

In an embodiment, the panel frame (114, 112, and 113) may comprise one solid material, or include separate parts. In another embodiment, the separate parts may include wood, and may be nailed together or otherwise attached. As shown, the interactive panels have side frame members 114, an upper frame member 112, and a lower frame member 113. Also, referring to FIG. 1, the music station 100 panels are on each side of the prism. As discussed below, the panels 118 can have musical devices disposed on them.

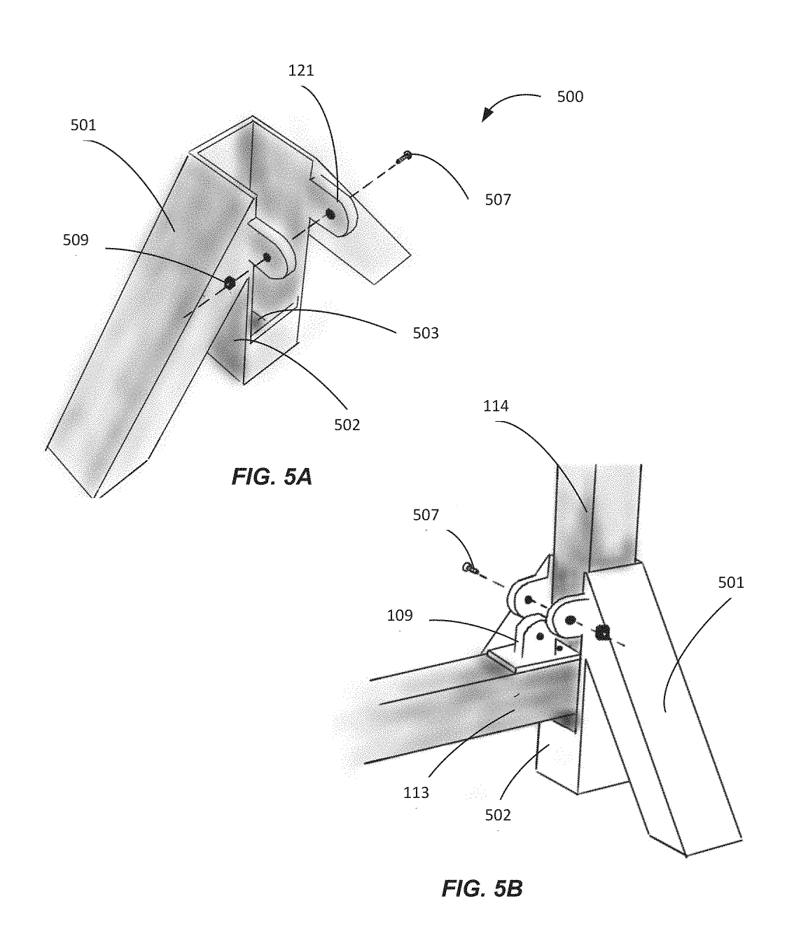

In a preferred embodiment, the side frame members 114 are 34″ tall and the upper and lower frame members (112 and 113) are 18.5″ long. Also, the lower frame member 113 toward the bottom of the interactive panel 118 can be offset e.g., mounted 2″ from the bottom of each panel 118, thereby providing extensions toward the bottom of the side frame members 113 of each panel 118. As discussed below, the panels 118 can stand on their own when the side frame members are inserted in to panel stabilizers 500 or “chicken foot” and stabilized as shown in FIGS. 5A and 5B, and as described below.

These dimensions also allow for adequate spacing for xylophone key placement also described below, allowing 1″ between keys 116 on the xylophone instrument. This also provides users ample room for interacting with panels 118 without disturbing other users (e.g., children, toddlers, or other playmates).

In a preferred embodiment, each of the interactive panels 118 have different musical devices removably disposed on the interactive panels. This is so that one or more users e.g., toddlers, children, or other user may interact with the interactive panels 118. Also, as shown in FIG. 1 the station 100 comprises a plurality of upper and lower brackets (103 and 111, respectively). Upper brackets 103 are illustrated in FIG. 1 as joining and securing the four upper corners of the interactive panel 118 frames. The coupling aspect of the upper brackets 103 and lower brackets 111 are discussed further below.

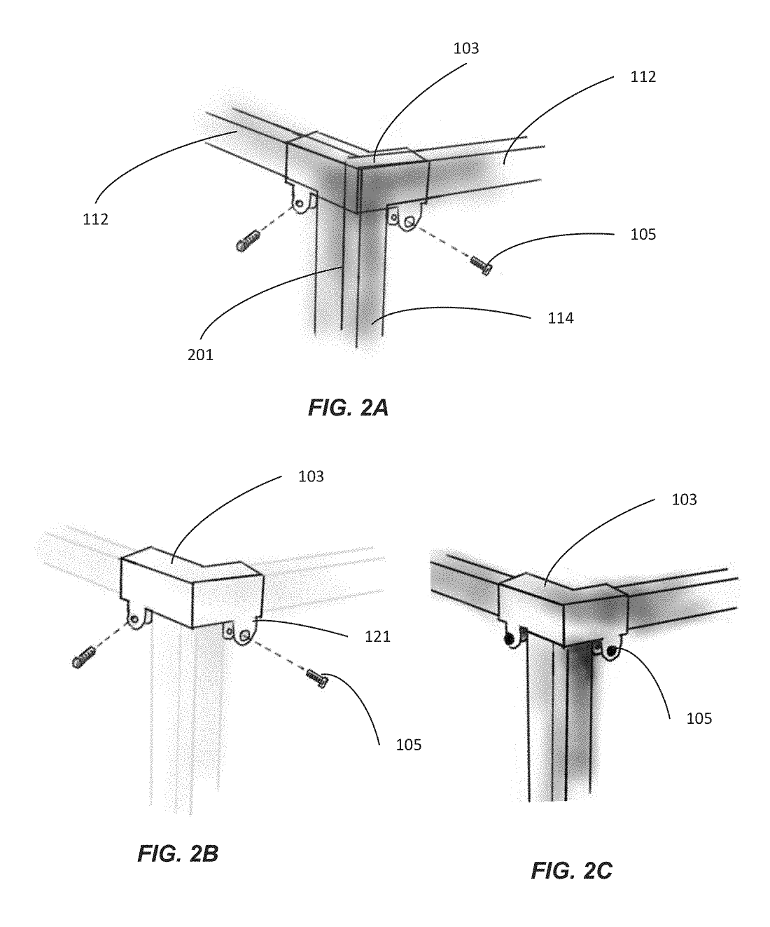

In a preferred embodiment, the upper brackets 103 comprise of hard plastic, having such durability and strength as necessary to join and or stabilize interactive panels 118 having abutting frames as depicted in FIGS. 1, 2A-2C. In other embodiments, however upper brackets 103 may comprise one or more of metal, wood, or other like material.

As discussed above, the music station 100 may have a variety of musical devices, instruments and the like, disposed on the interactive panels 118 of the music station 100. For example, in one embodiment there may be xylophone keys 116 removably disposed on one of the interactive panels 118. In another example, the front panel 118 of the music station 100 may include a Cymbal 115 that can be struck by a user using an accessory device or another object like a hammer 905 or mallet 903. In one embodiment, the hammers are made of materials such as wood, or other materials that would be safe for use.

Referring again to the example illustration of FIG. 1, musical devices may be fastened to the frame 113 of the music station 100 using one or more connectors 109. Preferably, connectors 109 comprise a hard plastic, and are disposed on the frame 118 members of the one or more interactive panels 118. In other examples, however, connectors 109 may be comprised of at least one metal, wood, or like materials.

Connectors 109 can be fastened to the frame members (112, 113, 114) of an interactive panel 118 using screws, nails, bolts, or other like attachment devices. In the one embodiment, the connectors 109 are attached using screws. Depending upon the type and size of the musical device to be disposed on the interactive panels, the placement of the connectors 109 may change.

Also, connectors 109 may come in different shapes and or sizes to satisfy its purpose. In one embodiment, however, each contains a hole in its center to allow one or more wires 119 of a steel rope, thread, or other like cord or like material to connect the musical device to the interactive panels 118. Using the Cymbal 115 in FIG. 1 for example, four wires are attached to each of four connectors 109 is shown. The other end of the wire 119 is connected to four holes in the Cymbal. Using this example, musical triangles 117 are also shown being disposed on the interactive panel 118 which is to the right of the interactive panel 118 having the Cymbal 115.

As discussed above, the upper brackets 103 of the music station 100 may be used to join interactive panels 118 that abut one another. Referring now to the bottom portion of each of the upper brackets 103, an eye bolt (i.e., bracket bolt 105) may be inserted through bracket extensions 121 on each side of the upper bracket 103 as shown. In an example, when the bracket bolt 105 is tightened or secured, it causes the upper bracket 103 to compress one or more of the interactive panel frame members (112, 113, 114), thereby joining or stabilizing the panels 118. However, in another example, bolts or other connectors are not needed for creating the compression necessary to join the interactive panels 118. Also of importance is that the music station 100 remain stable for safety purposes. The upper 103 and lower brackets 111 are used to ensure stability and safety for user interaction.

The discussion will now turn to a more detailed description of the upper brackets 103 of FIG. 1. FIGS. 2A-2C illustrate example views of an upper bracket 103 being used to join interactive panels 118 of the music station 100. Referring now to the upper brackets 103 shown in FIG. 2A, in the example illustration each upper bracket 103 is positioned on the top portion of two abutting panel frames members i.e., upper frames 112. Further as shown, the upper bracket may have at least two bracket extensions 121 on each side. The illustration of FIG. 2B also shows the shape of an upper bracket 103 in relation to the lighter shown frames of the interactive panels 118 that have been faded for distinction.

Each bracket extension 121 as shown in FIG. 2B in one example, has a hole within so that a bracket bolt 105 may be inserted as shown in FIG. 2C. A bracket bolt 105 may comprise a bolt combination, a screw, rod, wire, or like device that can be used to secure the upper bracket 103 to each of one or more frame members. As shown in each of the illustrations 2A-2B, the upper bracket 103 is disposed at the top of the upper corners of abutting frame members 112.

Further, the upper brackets 103 and lower brackets 111 as illustrated in FIGS. 1, 2A, and 2B are not limited to any angle, although 90 degrees is preferred when configuring the music station 100 in either the cube or rectangular configurations. In one embodiment, the music station 100 can enable users to configure the music station 100 into shapes and designs, while also learning about musical instruments, and be entertained.

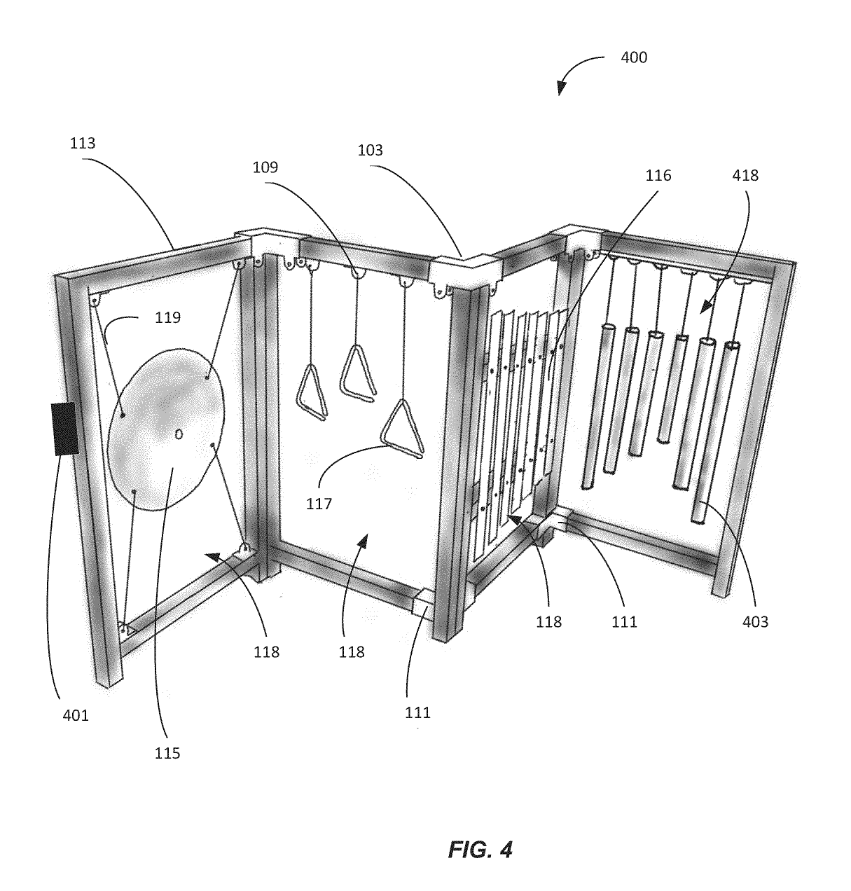

Moreover, if users prefer not to interact with the music station 100 next to one another, or perhaps the users require more individual space to learn, the music station 100 can be rearranged so that the music station 100 comprises one or more individual panels. The music station 100 may also form designs such as a zig-zag or angled design as illustrated and discussed below in reference to FIG. 4.

Users may define the sequence of panels 118 (joined or not joined using upper brackets 103 and lower brackets 111), for creative play. The frame members (112, 113, 114) of the music station can comprise wood, wherein the music station 100 may further be polished and or designed to be an aesthetically pleasing garden sculpture. The station 100 may also be an ornament of furniture, that can further be used for learning and playing while brining music in to the outdoor or indoor environment.

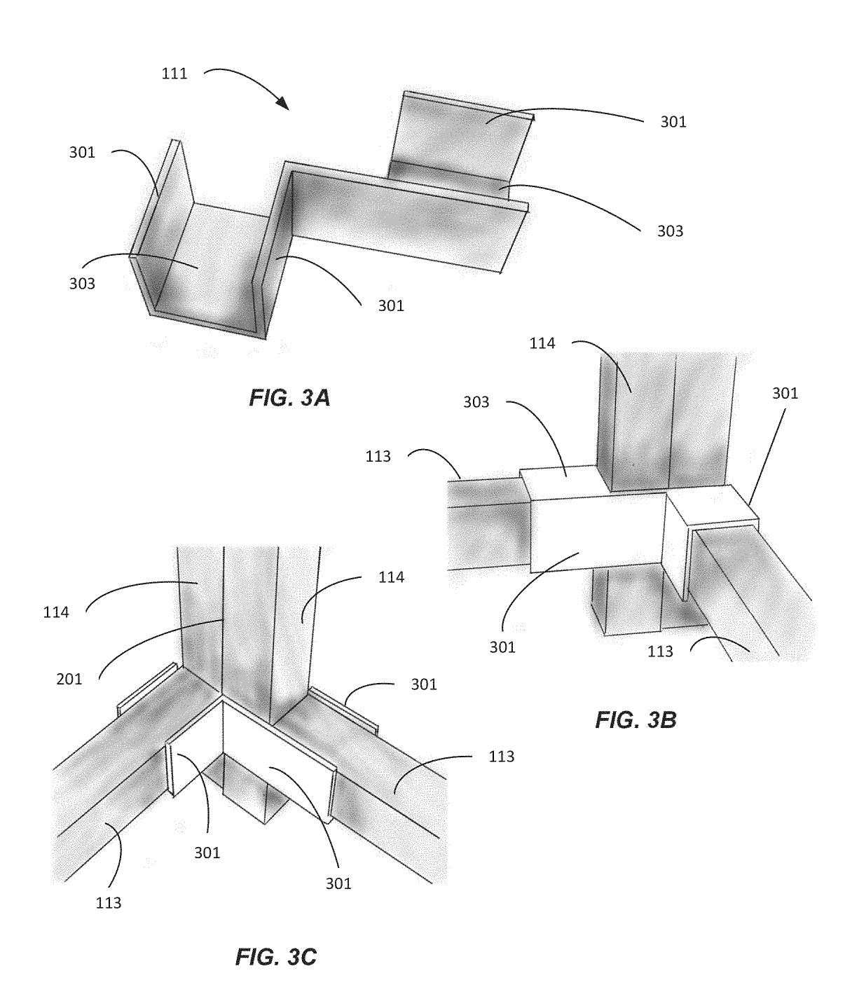

Referring now to FIGS. 3A-3C, example views of the lower bracket 111 are illustrated. FIG. 3A illustrates an example lower bracket, while FIGS. 3B-3C illustrate example views of lower brackets 111 positioned both on top and on the bottom of frame members 113. The lower brackets 111 can be used to join frame members of the interactive panels 118 of the music station 100 according to the present disclosure. In one example, the lower brackets 111 can join both frame members 113 and 114.

In a preferred embodiment, both the upper brackets 103 and the lower brackets 111 are angled in shape. Both the upper brackets 103 and the lower brackets 111 may be angled appropriately for configuring the music station 100 into different shapes and or designs. However, in one example the upper and lower brackets 111 can have an angle of 90°.

Example lower brackets 111 as illustrated in FIGS. 3A-3B and upper brackets 103 can be used to join interactive panels 118 that abut or are close in proximity. At least one purpose for this is so that the music station 100 may encompass different shapes and or designs. Referring to FIG. 3A, the lower bracket 111 preferably comprises a hard plastic, but may otherwise comprise one or more metal, wood, or like material. The lower brackets 111 can be used for joining interactive panel 118 frames 113. In an example implementation, the lower bracket 111 has at least one base, and one or more compression arms 301.

As shown in FIG. 3B, the lower bracket 111 has been disposed on lower frame members 113 of first and second panel frames 113. The lower frame member 113 of the interactive panel 118 is the lower or bottom most frame member of an interactive panel 118. The lower frame 113 members of different interactive panels 118 are joined against each at a junction 201, as illustrated in FIG. 3C. The compression arms extending from the sides of the bracket base 303 as illustrated apply a compressive force to the lower frame member 113 when placed thereon. The compression from the compression arms may be created by angling the compression arms or otherwise designing the width between the compression arms so that they form a firm grip on the lower frame members 113.

The inside of each of the compression arms 301 may also include an edged, serrated, or ribbed surface area. This is so that after the lower bracket 111 has been disposed on the lower frame member 113, the friction created between the lower frame member 113 and the lower bracket 111 is increased to ensure that the lower bracket 111 will remain stabilized when the frames of interactive panels 118 are joined. The lower bracket 111 as illustrated in FIG. 3B is shown disposed on top of the lower frame members 113. Also, as shown, compression arms 301 are extending downwards with respect to each lower bracket 111 base.

This is at least one example of using the lower bracket 111 to join frames of interactive panels 118. In another example shown in FIG. 3C, the lower bracket 111 may be reversed or upside down, i.e., positioned on the lower frame members 113 of the interactive panels 118 wherein the bracket base 303 is disposed on the underside of each lower frame member 113 as shown.

In this implementation, the lower bracket 111 may be disposed in a way that the top portion of the lower frame member 113 is exposed. This allows the lower bracket 111 to be disposed on the music station 100 while also allowing other devices such as one or more connectors 109 to be disposed on the top portion of the lower frame member 113.

In either example, the compression provided by the lower bracket 111 compression arms 301 has to be enough to stabilize the interactive panels 118. Further, the compression arms 301 of the lower bracket 111 are not limited to only using compression to join the lower frame members 113, as like the upper brackets 103 the lower brackets may join the frames members 113 using similar bracket extensions 121 and bolts 105.

Now that we have discussed an example configuration of the configurable music station 100, we now turn to a description of the Zig-Zag or angled configuration. FIG. 4 illustrates an angled or Zig-Zag configuration of the music station 100 according to the present disclosure.

As shown, the angled music station 100 does not have the form of either a cube or rectangular prism as discussed above. Instead, the music station 100 as illustrated has a Zig-Zag or angled design. The angled music station 100 interactive panels 118 can be joined to each other using both upper brackets 103 and lower brackets 111 as discussed above. The angled or Zig-Zag configuration may be ideal when users such as children need more space to learn and to interact with one or more of the interactive panels 118. As discussed below, the configurable music station 100 can be configured to include a single interactive panel 118. In one embodiment, if a user needs more space than the angled configuration can provide, the single interactive panel 118 configurations may provide more space.

Referring again to the illustration of FIG. 4, the first panel 118 has a Cymbal 115 in the middle. The Cymbal 115 as illustrated can be connected to one or more different connectors 109 disposed on the music station 100 by wires 119 discussed above. In a preferred embodiment, the Cymbal 115 is connected to four connectors 107 using 1/16″ steel wire rope (119) and an aluminum cable crimp.

As illustrated, the interactive panel 118 having the Cymbal 115 disposed also has an accessory member 401 on the side of the interactive panel 118 frame 113. Accessory members 401 in a preferred implementation comprise plastic, however in other implementations they may include, wood, one or more metal, or other like material.

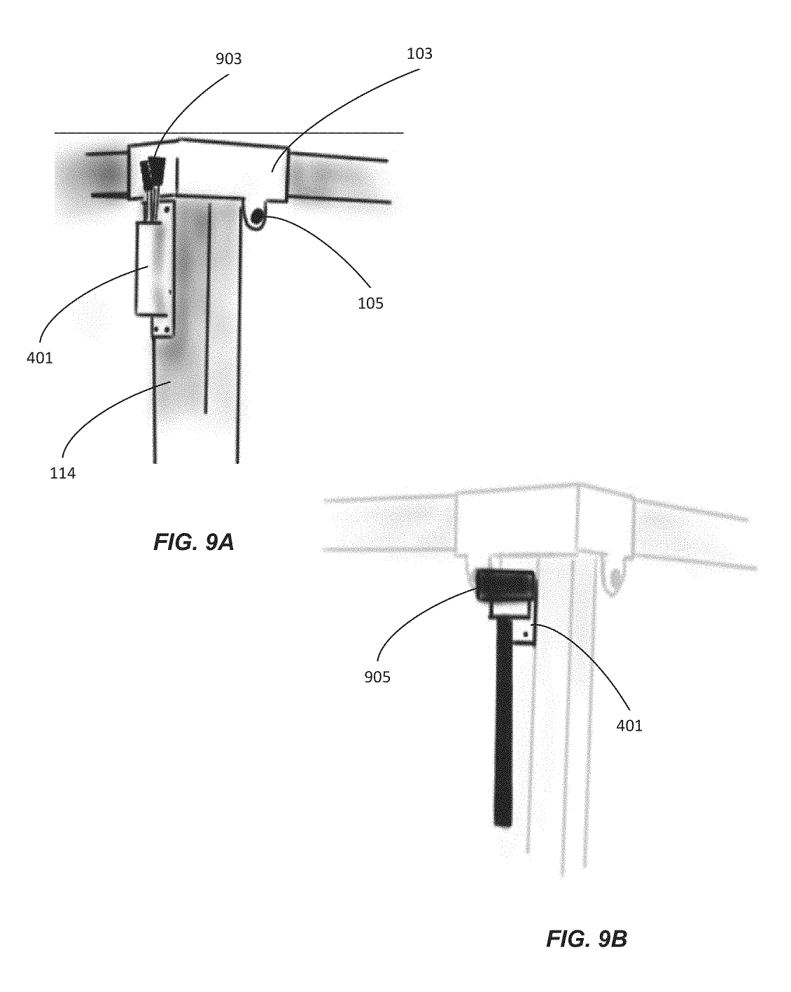

The accessory members 401 serves as an accessory compartment for holding accessory devices used when interacting with musical devices disposed on the interactive panels 118. For example, a device such as a mallet 903 or a hammer 905 may be used to interact with the Cymbal 115 disposed on the left most interactive panel 118 of FIG. 4. Using this example, accessory devices like the hammer 905 or mallets 903 may be stored in the one or more accessory members as illustrated in FIG. 4, and as further described below in reference to FIGS. 9A-9B. Furthermore, the accessory members disclosed above may be disposed on one or more interactive panel frames 113 and can house more than one device used to interact with the musical devices.

Referring to the second panel 118 i.e., the interactive panel 118 to the right of Cymbal 115, music triangles 117 are shown. Triangles 117 can be one of the musical devices used with the music station 100, and can be connected to the interactive panels 118 via connectors 109 and or wire 119. Also, although not limited to, preferably the triangles 117 are connected to the connectors 109 using 1/16″ steel wire rope with a loop made using an aluminum cable crimp. Using the above example, the triangles 117 are mounted loosely to allow for reverberation and giving a clear sound when struck by accessory devices used to interact with the musical devices.

Users may use the lower brackets 111 and upper brackets 103 as needed to configure and or stabilize the music station 100 during interaction. The upper brackets 103 and lower brackets 111 can be used to stabilize interactive panels 118 in an upright position, so that disposed musical devices (such as the cymbal, triangle, etc.) are enabled for user interaction e.g., such as being positioned so that children can interact the musical device. Further, although many other musical devices may be disposed on the music station 100, example instruments used herein may be a xylophone and chimes, as shown in FIG. 4.

The discussion will now turn to another example configuration of the music station 100. As discussed above, to give a user the most space the music station 100 may include a single interactive panel 118. In one embodiment of the invention, this configuration can be used independently by single or multiple users, and may not require upper brackets 103 or lower brackets 111 for stabilizing the interactive panel frames 113. In one example of this configuration the music station 100 may use one or more stabilizer connectors 500 for stabilizing and holding the music station 100 upright according to the illustrated example of FIGS. 5A and 5B.

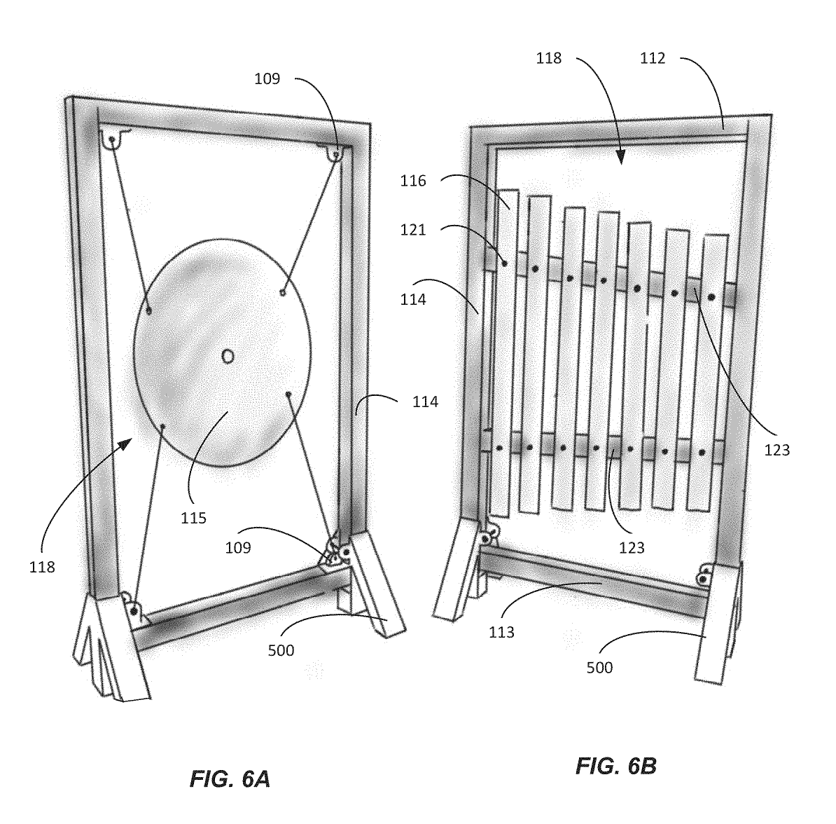

Referring now to FIGS. 5A-5B, interactive panel stabilizers 500 are illustrated, according to the present disclosure. In a preferred embodiment, panel stabilizers 500 are used to stabilize a single interactive panel 118, as shown in the example illustrations of FIGS. 6A-6B. Panel stabilizers 500 may be disposed at the base of the interactive panels 118, on each side of the panels 118. This allows the interactive panels 118 to be positioned upright. In a one embodiment, the panel stabilizers 500 comprise hard plastic, but may also comprise other material such as one or more metals, wood, or other like material.

As illustrated in FIGS. 5A and 5B in the preferred embodiment, panel stabilizers 500 may include bracket extensions 121. The extensions 121 may be used to compress the stabilizer housing on or around the side frame member 114 of an interactive panel 118, as shown in FIG. 5B. In one example, frame member 114 of an interactive panel 118 is disposed within the panel stabilizer 500, inside the stabilizer housing.

In another example the side frame member 114 may rest within the stabilizer base, and a stabilizer bolt 507 and fastener 509 may be used to compress the stabilizer housing around the side frame member 114 disposed within. Once the panel stabilizer 500 housing is compressed the stabilizer legs 501 may be used to provide stability to the interactive panel 118 being stabilized. Also, as shown in FIG. 5B one or more connectors 109 may be used in conjunction with panel stabilizers 500 and can be used for disposing musical devices within the interactive panels 118.

As illustrated in FIGS. 6A and 6B, panel stabilizers 500 may side frame members 114 of an interactive panel 118 disposed within. In this example, the panel stabilizer 500 may stabilize the interactive panels 118 so that they are held in an upright position. As discussed above, the interactive panels 118 may be stabilized by disposing the frames of the interactive panels 118 into panel stabilizers 500 and using panel stabilizers 500 to compress and or apply pressure to the frames.

Referring to the illustration of FIG. 6B, keys 116 of a xylophone are shown disposed on an interactive panel 118. Per a preferred implementation, the interactive panel 118 may have additional frame members 123, and the xylophone keys 116 may be removably disposed on the frame members 123 using a mounting screw assembly 700. The Xylophone can comprise aluminum hand polished keys 116 having a thickness of ¼″ and may be mounted with the mounting screw assembly 700, as discussed below.

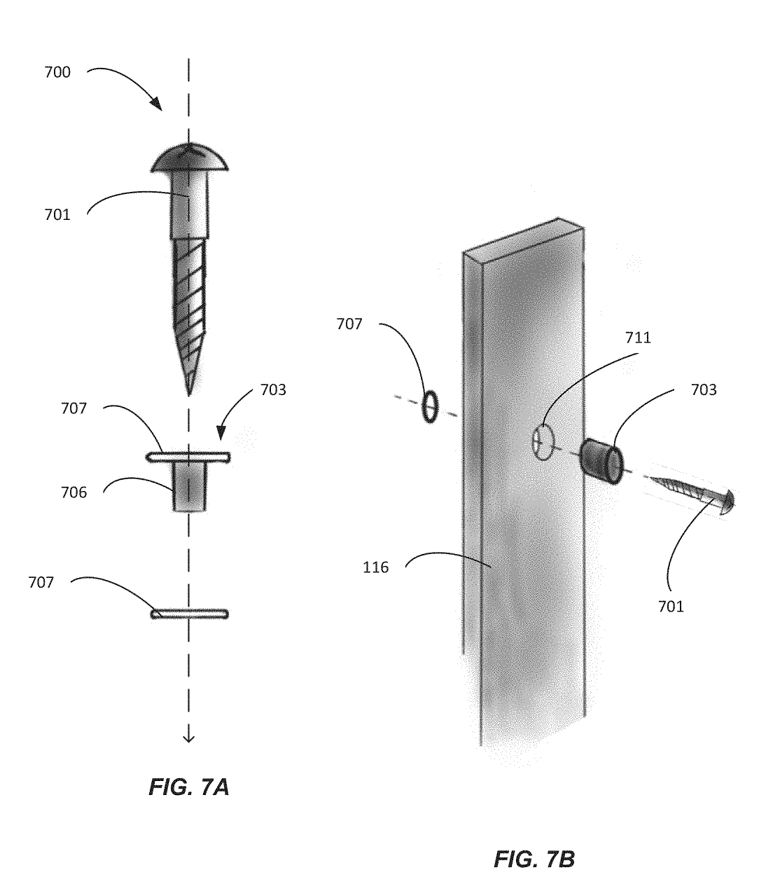

The mounting screw assembly 700 as shown in FIGS. 7A-7B may include mounting screws 701 disposed within washers 707 and a plastic housing 706, as shown. In another example, however, other screws, bolts, or like apparatuses for securing keys 116 of the xylophone as shown may be used as mounting screws 701. Also, although a xylophone is used in this example, the mounting screw assembly 700 can be used to mount other musical devices within the interactive panels 118.

As shown in FIGS. 7A-7B, insert 703 may include a washer 707 disposed on a housing 706 (sheath). However, in another example, the insert 703 may comprise a washer 707 and a separate sheath 706, wherein the washer 707 is not disposed on the sheath. Preferably however, the sheath 706 comprises plastic and each of the washers comprise “O” rings on either side of the Xylophone keys 116. This is so to reduce or prevent metal on metal contact and unwanted noise during interaction.

Referring now to the example illustrated in FIG. 7B, as shown a mounting screw is disposed into an insert, wherein the insert 703 includes a housing and an O ring washer. As disclosed, the insert 703 is disposed in an opening 711 in the key, where the insert 703 also has a hole through it to allow the screw to be inserted through the xylophone key 116 and into the additional frame members 123 as shown in FIG. 6B.

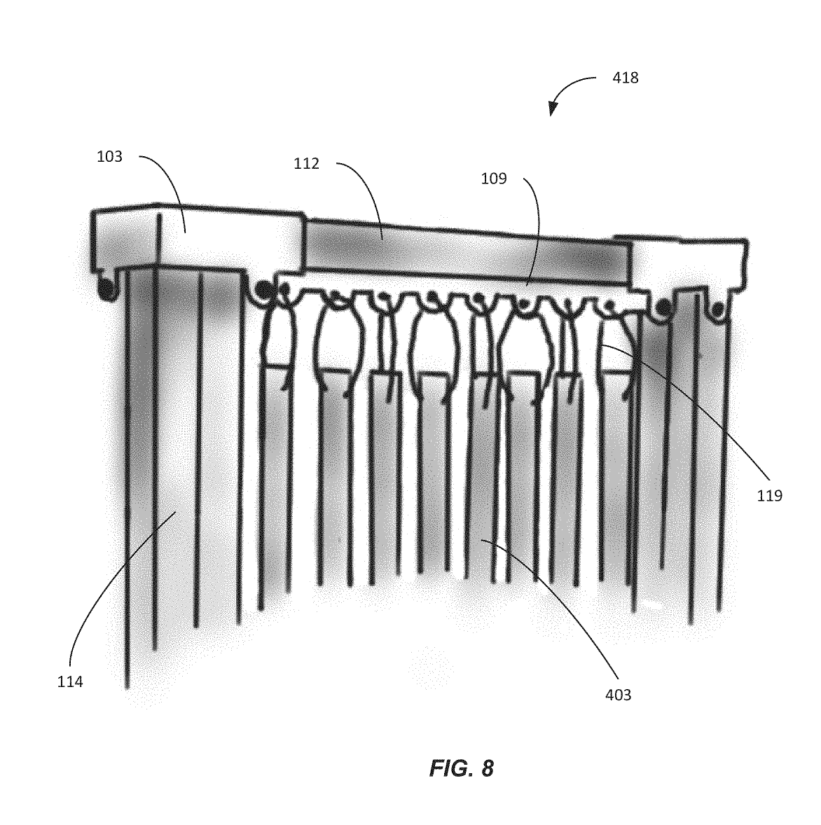

FIG. 8 illustrates an example chime panel 418 according to the present disclosure. The chime panel 418 can be disposed in an interactive panel 118 and include one or more chimes as known in the art. The chime panel 418 is also shown in the example illustration of FIG. 4 having one or more connectors 109 disposed on the upper frame member 112 as shown.

In one example, the chimes 403 can be arranged in a way wherein each chime 403 is connected to its own individual connector 109 as shown. In the preferred embodiment of the invention chimes 403 include hand polished copper pipe having a thickness of ⅞″ mounted with a 1/16″ steel rope. Using this example, wire 119 such as steel rope can be weaved through a connector 109 as shown. The wire 119 may also be kept loose to allow the keys 116 to reverberate for clarity of sound.

Referring again to the illustration of FIG. 8, the connector 109 may be a single connector 109 having a plurality of holes. Using the example of FIG. 8, each of the chimes 403 may be connected through one or more holes in the connector 109. The chimes 403 may be coupled or connected to the connectors 109 via the wire 119.

FIGS. 9A-9B illustrate one or more mallets 903 and a hammer 905 disposed within accessory members attached to the music station frame 113. As discussed above, the one or more accessory members 401 serve as an accessory compartment for holding accessory devices that can be used when interacting with musical devices disposed on the interactive panels 118. The accessory members 401 discussed above may be attached to the frame members (112, 113, 114) using nails, screws, adhesive or like devices or substances.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

In exchange for disclosing the inventive concepts contained herein, Applicants desire all patent rights afforded by the appended claims. Therefore, it is intended that the appended claims include all modifications and alterations to the full extent that they come within the scope of the present disclosure.

What is claimed is:

1. A musical learning apparatus comprising:
one or more interactive panels including side frame members, an upper frame member, and a lower frame member;
one or more connectors disposed on at least one of the side frame members, upper frame member, and lower frame member;
a plurality of upper brackets, the upper brackets positioned on abutting upper frame members;
a plurality of lower brackets, the lower brackets positioned on abutting lower frame members;
wherein one or more wires connect musical devices to at least one of the interactive panels using the connectors; and
wherein when the upper and lower brackets stabilize the abutting upper and lower frame members the musical devices are enabled.

2. The musical learning apparatus of claim 1, wherein when the interactive panels are stabilized the musical learning apparatus forms a shape or design.

3. The musical learning apparatus of claim 2, wherein the shape or design includes at least one of a rectangular prism, cube, Zig-Zag, square, or rectangle.

4. The musical learning apparatus of claim 1, wherein the upper brackets and lower brackets are angled in shape.

5. The musical learning apparatus of claim 1, wherein the upper brackets and lower brackets use compression to stabilize the upper and lower frame members.

6. The musical learning apparatus of claim 1, wherein when the lower brackets are positioned on abutting lower frame members, the lower brackets are in a reversed position.

7. The musical learning apparatus of claim 1, wherein the lower frame members are offset from the bottom of the interactive panels.

8. The musical learning apparatus of claim 1, wherein the one or more interactive panels further comprise one or more additional frame members.

9. The musical learning apparatus of claim 8, wherein one or more xylophone keys are disposed on the additional frame members using a mounting screw assembly.

10. The musical learning apparatus of claim 9, wherein the mounting screw assembly includes a mounting screw, one or more washers, and a sheath.

11. The musical learning apparatus of claim 10, wherein the one or more xylophone keys are disposed on the additional frame members when the mounting screw is inserted through the sheath and the washers, and into the additional frame members.

12. The musical learning apparatus of claim 10, wherein the sheath is disposed in an opening within the xylophone key, the sheath and washers isolate the mounting screw from the xylophone keys.

13. A musical learning apparatus comprising:
an interactive panel including side frame members, an upper frame member, and a lower frame member;
one or more connectors disposed on at least one of the side frame members, upper frame member, and lower frame member;
two or more panel stabilizers disposed at the base of the interactive panel;
wherein at least one wire connects one or more musical devices to the interactive panels using the connectors;
wherein the side frame members of the interactive panel are disposed within the panel stabilizers; and
wherein the musical devices are enabled when the panel stabilizers stabilize the interactive panel.

14. The musical learning apparatus of claim 13, wherein stabilizing the interactive panel involves using compression.

15. The musical learning apparatus of claim 13, wherein panel stabilizers include a housing and at least one bracket extension.

16. The musical learning apparatus of claim 15, wherein the interactive panel is stabilized when the housing is compressed on the frame of the interactive panel.

17. The musical learning apparatus of claim 13, wherein the interactive panel further comprises at least one additional frame member.

18. The musical learning apparatus of claim 17, wherein one or more xylophone keys are disposed on the at least one additional frame member using a mounting screw assembly.

19. The musical learning apparatus of claim 18, wherein the mounting screw assembly includes, a mounting screw, one or more washers, and a sheath.

20. The musical learning apparatus of claim 19, wherein the sheath is disposed in an opening within the xylophone key, wherein the sheath and washers isolate the mounting screw from the xylophone key.
